(19) United States
(12) Patent Application Publication
(10) Pub. No.: US 2011/0060663 A1
(43) Pub. Date: Mar. 10, 2011

(54) System and Method of Providing Customer Purchase Propensity Information to Online Merchants

(75) Inventors: Michael McPhie, Palo Alto, CA (US); Manav Gupta, Redwood City, CA (US); Charles Wilson, Palo Alto, CA (US)

(73) Assignee: Visa U.S.A. Inc.

(21) Appl. No.: 12/879,200

(22) Filed: Sep. 10, 2010

Related U.S. Application Data
(60) Provisional application No. 61/241,268, filed on Sep. 10, 2009.

(51) Int. Cl. G06Q 30/00

(52) U.S. Cl. 705/27.1

(57) ABSTRACT

A system for providing online merchants with purchase propensity information is provided. The system includes a processor and a purchase propensity module executable by the processor. The purchase propensity module receives, from an online merchant computer, a message containing a customer identifier that identifies a customer who has established an online browsing session with the online merchant. In response, the purchase propensity module transmits to the online merchant computer purchase propensity data associated with the identified customer while the browsing session is in progress. This allows the online merchant computer to determine a targeted offer for the user while the user is in the online browsing session.

### CROSS REFERENCE TO RELATED APPLICATIONS

This application claims the benefit of U.S. Provisional Application No. 61/241,268, filed Sep. 10, 2009, which is incorporated by reference herein.

### FIELD OF THE INVENTION

The present invention relates to data processing, and in particular relates to a method and system of providing customer purchase propensity information to online merchants.

### BACKGROUND OF THE INVENTION

In conventional electronic commerce (eCommerce) transactions, a prospective customer working on a computer may establish a browsing session with an online merchant (e.g., a merchant web site over the Internet), and select items offered for sale on the merchant web site for purchase. After the selection, a checkout process begins in which the customer provides payment information such as an account number of a financial presentation device.

A financial presentation device is a device that can be presented to sellers of goods or services for payment and includes, but is not limited to, credit cards, debit cards, prepaid cards, electronic benefit cards, charge cards, virtual cards, smart cards, key chain devices, personal digital assistants, cell phones, stored value devices and the like.

In an attempt to increase sales, during the selection or checkout process, the online merchant may review the user-selected items and try to offer additional related items to the customer. However, without knowing more about the customer, the attempted additional offer based solely on the items selected is likely to generate little interest by the customer.

Therefore, it would be desirable to provide a system and method for providing more detailed information about the customer to online merchants so that targeted offers that are more relevant to each customer can be made while the customer is online with the merchant.

### SUMMARY OF THE DISCLOSURE

In one aspect of the invention, a system for providing online merchants with purchase propensity information is provided. The system includes a processor and a purchase propensity module executable by the processor. The purchase propensity module receives, from an online merchant computer, a message containing a customer identifier that identifies a customer who has established an online browsing session with the online merchant. In response, the purchase propensity module transmits to the online merchant computer purchase propensity data associated with the identified customer while the browsing session is in progress. This allows the online merchant computer to determine a targeted offer for the user while the user is in the online browsing session.

In another aspect of the invention, a system for an online merchant to provide a targeted offer based on purchase propensity information is provided. The system includes a processor and a sales management module executable by the processor. The sales management module interacts with a customer computer to establish an online browsing session with a customer, retrieves purchase propensity data associated with the customer, and determined a targeted offer for the customer based on the retrieved purchase propensity data while the browsing session is in progress.

In another aspect of the invention, a method for providing online merchants with purchase propensity information is provided. The method includes receiving, from an online merchant computer, a message containing a customer identifier that identifies a customer who has established an online browsing session with the online merchant. In response, the purchase propensity data associated with the identified customer is transmitted to the online merchant computer while the browsing session is in progress. This allows the online merchant computer to determine a targeted offer for the user while the user is in the online browsing session.

### BRIEF DESCRIPTION OF THE DRAWINGS

FIG. 1A is a functional block diagram of a system for providing purchase propensity data according to one embodiment of the invention.

FIG. 1B is a functional block diagram of a system for providing purchase propensity data according to another embodiment of the invention.

FIG. 2 is a functional block diagram of a computer that can be used by any entity shown in FIGS. 1A and 1B.

FIG. 3 illustrates an exemplary purchase propensity data of a customer according to the invention.

### DETAILED DESCRIPTION OF THE INVENTION

When a financial presentation device is used for payment, an authorization procedure takes place during the checkout process in which the online merchant passes transaction data in an authorization request to an authorizing entity such as the issuer of the financial presentation device via a financial transaction facilitator such as Visa™. A financial transaction facilitator is a network that acts as a switch between acquirers and issuers for routing messages therebetween for purposes of authorization, clearing and/or settlement of financial transactions.

Financial transaction facilitators such as Visa typically maintain databases that store information regarding the customer accounts. The stored information includes records of past purchase transactions performed by the customers using their accounts.

Since the stored information includes transaction records from not just one merchant but all of the merchants that have processed the transactions through the financial transaction facilitator, the information data set is much larger than the amount of information that can be collected by a single merchant. Accordingly, the large historical purchase data of the financial transaction facilitator may more comprehensively reveal customers' purchase habits and propensities which may be very valuable to online merchants.

The present invention provides a system and method for providing such purchase propensity information to online merchants while the browsing session with the customer is in progress so as to assist the online merchant to make more precisely targeted offers for that customer.

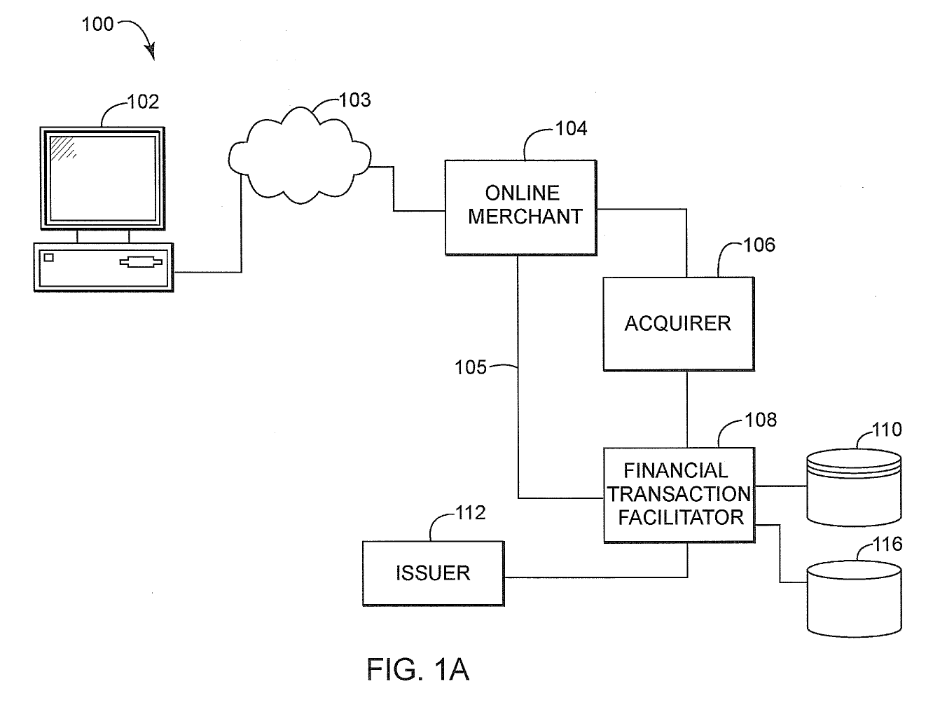

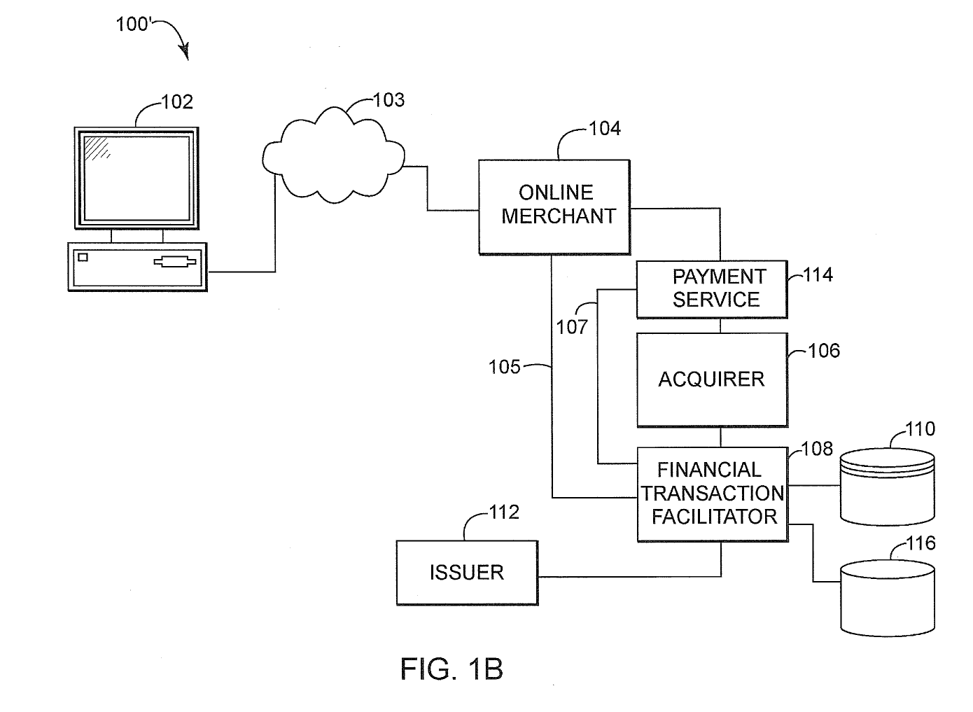

FIG. 1A shows a system 100 for performing financial transactions using a financial presentation device according to the present invention. A customer at a computer (e.g., desktop, laptop, mobile computing device, mobile phone or the like) 102 is communicatively coupled to a computer network such as the Internet 103 and may access sites hosted by online merchant (merchant computers) 104 on which goods and/or services offered by the merchant are displayed. Online merchant computer 104 is coupled to a private secure network over which transaction data are transmitted. The private network includes acquirer (acquirer computers) 106 which receive data from merchants, data centers of the financial transaction facilitator 108 where processing may take place and issuers (issuer computers) 112 of financial presentation devices such as credit and debit cards.

A communication link 105 connects the online merchant computer 104 to the financial transaction facilitator computer 108 over which the purchase propensity data are transmitted which will be discussed in detail later herein. A purchase history database 110 coupled to the financial transaction facilitator 108 stores historical data for purchases made from a plurality of merchants for a plurality of customers that use financial presentation devices for payment. A purchase propensity database 116 also coupled to the financial transaction facilitator 108 stores purchase propensity data of customers based on the historical purchase data contained in the purchase history database 110. These databases will be discussed in more detail later herein.

In operation, when a financial presentation device is used to make an online purchase, an authorization request including data pertaining to the purchase transaction flows from the online merchant 104 to the acquirer 106, and from acquirer 106 to the financial transaction facilitator 108. Financial transaction facilitator 108 determines the issuer that issued the presentation device and routes the authorization request to the determined issuer 112 among a plurality of issuers. The issuer 112 determines whether the account (financial presentation device) is authorized and prepares an authorization response to either authorize or decline the transaction. The issuer authorization response is then transmitted to the merchant 104 through the transaction facilitator 108 and then the acquirer 106. During the transaction, the transaction facilitator 108 stores in a database 110 details of the transaction data. In some embodiments, the issuer 112 stores at least some of the transaction data details which the financial transaction facilitator 108 may then access.

FIG. 1B shows a system 100′ for performing financial transactions using a financial presentation device according to another embodiment of the present invention. A payment service (payment service computer) 114, such as CyberSource Corporation of Mountain View, Calif., may be positioned between the online merchants and acquirers to assist the merchants with payment services.

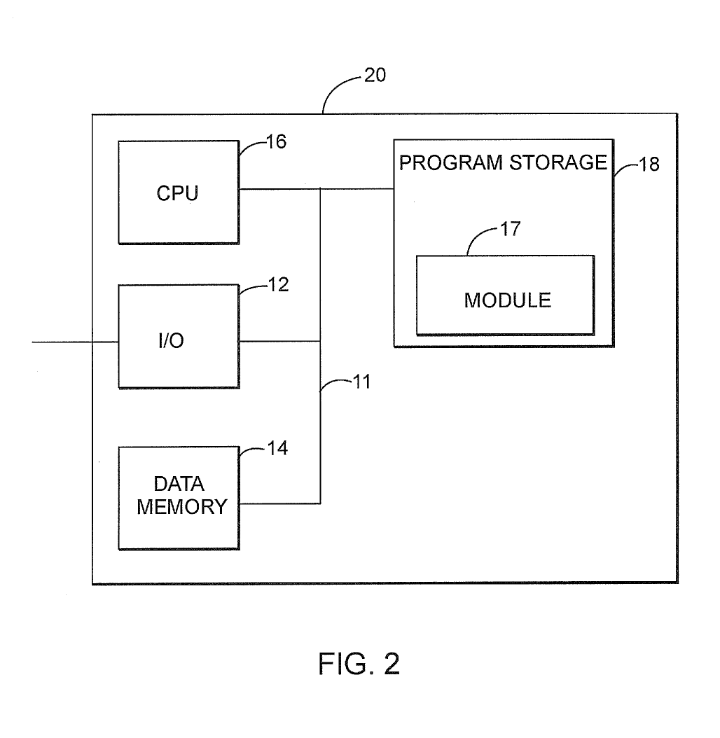

FIG. 2 illustrates a computer system 20 that can be used as the customer computer 4, merchant computer 104, issuer computer 112, payment service computer 114, acquirer computer 106, or financial transaction facilitator computer 108. A computer that manages analysis and determination of purchase propensity data may be a separate computer or a part of the financial transaction facilitator computer system 108 that routes messages for purposes of authorization, clearing and/or settlement of financial transactions originating from the merchants 104.

For purposes of this application, the terms “code”, “program”, “application”, “software code”, “software module”, “module” and “software program” are used interchangeably to mean software instructions that are executable by a processor.

The system 20 includes a communication interface 12, a processor (CPU) 16, a memory 14, 18 coupled to the processor, and software or software modules 17 executable by the processor. The elements 12,14,16,18 are all connected to each other through a common bus 11.

As a merchant computer, the module 17 may include a sales management module that interacts with the customer computer to establish a browsing session, manage sales transactions and make targeted offers based on the customer's purchase propensity data. As a financial transaction facilitator computer, the module 17 may include a purchase propensity module that derives purchase propensity data from the purchase history database 110 for storage in the purchase propensity database 116 and that interacts with merchant computer 104 to provide such data.

When the customer visits or logs in to the online merchant site through the Internet 103, the sales management module 17 of the merchant computer 104 interacts with the customer computer 102 to establish a browsing session. The sales management module 17 of the merchant computer 104 can implant and retrieve data/code in customer computers in the form of ‘cookies’ that allow the merchant to automatically recognize the customer. While the user is browsing the pages of the online merchant, the sales management module 17 assembles a request message (request to retrieve purchase propensity data about the customer) containing a customer identifier.

The customer identifier preferably is a financial account number of the customer, but it can be anything that can identify the customer to the financial transaction facilitator 108 such as the name of the customer and address. The customer identifier may be retrieved from the merchant's database or from the cookies themselves. For example, the online merchant 104 may automatically detect that the customer has used a particular financial presentation device (FPD) in a past transaction with the online merchant. The assembled message is then sent to the financial transaction facilitator computer 108 through either the link 105, 107 or acquirer computer 106.

The purchase propensity module 17 of the financial transaction facilitator computer 108 receives the message. Preferably, the purchase propensity module 17 has derived the propensity data by analyzing the purchase transaction history of the customer in the purchase history database 110 and stored them in the purchase propensity database 116.

Based on the account identifier contained in the received message, the purchase propensity module 17 retrieves the customer's purchase propensity data from the database 116. Alternatively, purchase propensity module 17 of the financial transaction facilitator 108 may retrieve the customer's purchase history from the database 110 and generate the customer's purchase propensity information upon receiving the message from the merchant computer 104.

It is to be noted that the customer's propensity information can be derived without using the purchase history and solely from customer's personal information such as residential address, zip code, annual income, age and the like. Alternatively, the customer's propensity information can be derived with the purchase history and customer's personal information.

The purchase propensity module 17 then transmits the customer's purchase propensity data to the online merchant computer 104 through either the link 105, 107 or acquirer computer 106.

The sales management module of the merchant computer 104 uses the received purchase propensity data to determine a more targeted offer for the customer while the customer is in the browsing session so that such an offer can be made before the customer leaves the merchant site.

As can be appreciated, because the transaction facilitator computer 108 is connected to a plurality of merchants including online and brick and mortar merchants, the purchase data for a particular account includes data from many merchants. Also, because the transaction facilitator 108 is connected to a plurality of issuers 112, it is possible for the transaction facilitator to pass customer identifying information to the issuers and obtain other financial accounts that the customer owns so that the historical purchase data of the customer may include not only those of one account but multiple accounts from different issuers.

In one embodiment, the purchase propensity data includes propensity scores that are based on one or more of the following parameters although other parameters can be used: 1) number of transactions and amount of spend by merchant; 2) number of transactions and amount of spend by merchant type or category; 3) velocity of spend; 4) seasonality of spend; 5) quantity and mix of spend by channel (online, face-to-face, mail order/telephone order transactions); 6) past responsiveness to special offers and/or discounts; 7) spend by financial presentation device type (debit, credit, prepaid); and 8) average transaction amount of spend.

The online merchants can be provided with a guideline as to how to interpret the propensity scores. For example, the following table illustrates one guideline for online merchants.

TABLE 1

| Propensity | |
|---|---|
| Score Range | Description |
| 0 to 20 | Customer has made no purchases in this category nor in |
| | complementary categories |
| 21 to 40 | Customer has made no purchases in this category but has |
| | made purchases in complementary categories |
| 41 to 60 | Customer has made less then 5 purchases in this category |
| | in the last time period |
| 61 to 80 | Customer has made 10+ purchases in this category and |
| | 5 in complementary categories |
| 81 to 100 | Customer has made 10+ purchases in this category and |
| | 10+ in complementary categories |

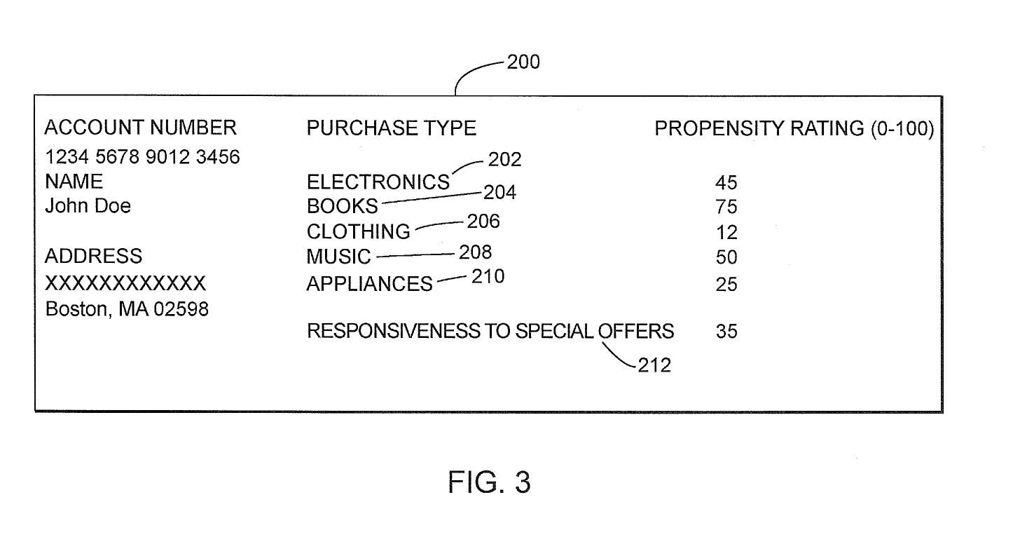

FIG. 3 shows a table including exemplary purchase propensity data of an example customer “John Doe”. The table 200 includes a list of categories 202-212 of goods and services and indicates a propensity score for each of the categories, where a higher propensity score indicates a greater propensity to purchase goods or services of the particular category. The category 204 with the highest propensity score is “Books”, indicating that book sellers may be interested in targeting this customer. One of the categories 212 indicates the propensity of the customer to respond to targeted offers, and may be particularly useful to merchants. For example, a merchant may target a customer that has a high propensity to respond to offers regardless of whether the merchant offers goods or services that a customer tends to purchase. This type of information as well as other types and categories, including actual historical purchase data, may be provided to online merchants while the customer is in the browsing session according to the present invention.

In an alternative embodiment, the propensity data can be provided to an online merchant in advance so that the merchant can set up a targeted marketing program to target a specific set of its customers. That way, as soon as the customer establishes an browsing session with the merchant's website, the online merchant can check its own purchase propensity database to determine whether the logged-in customer is part of the targeted set of customers without sending the account identifying information to the transaction facilitator 108.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

What is claimed is:

1. A system for providing online merchants with purchase propensity information, the system comprising:
a processor;
a purchase propensity module executable by the processor and adapted to:
receive, from an online merchant computer, a message containing a customer identifier that identifies a customer who has established an online browsing session with the online merchant; and
responsive to the received message, transmit to the online merchant computer purchase propensity data associated with the identified customer while the browsing session is in progress.

2. The system of claim 1, further comprising:
a purchase history database that stores historical data for purchases made from a plurality of merchants for a plurality of customers, wherein the purchase propensity module determines the purchase propensity data based on the historical purchase data contained in the purchase history database.

3. The system of claim 1, further comprising a purchase propensity database that stores purchase propensity data for a plurality of customers and the purchase propensity module retrieves the purchase propensity data for the identified customer from the purchase propensity database for transmission to the online merchant computer.

4. The system of claim 1, further comprising a purchase propensity database that stores purchase propensity data for a plurality of customers, wherein the purchase propensity module determines the purchase propensity data based on historical purchase data for storage in the purchase propensity database.

5. The system of claim 1, wherein the purchase propensity module determines the purchase propensity data based on one or more of the following:
number of transactions and amount spend;
velocity of spend;
seasonality of spend; and
average transaction amount.

6. The system of claim 1, wherein the purchase propensity module determines the purchase propensity data based on responsiveness to past offers or discounts.

7. A system for providing online merchants with purchase propensity information, the system comprising:
a purchase propensity database that stores for a plurality of customers purchase propensity data derived from historical data for purchases made from a plurality of merchants;
a processor coupled to the purchase propensity database;
a purchase propensity module executable by the processor and adapted to:
receive, from an online merchant computer, a message containing a customer identifier that identifies a customer who has established an online browsing session with the online merchant; and
responsive to the received message, retrieve purchase propensity data associated with the identified customer from the purchase propensity database;
transmit the retrieved purchase propensity data to the online merchant computer while the browsing session is in progress.

8. The system of claim 7, further comprising a purchase history database from which the purchase propensity data are derived.

9. The system of claim 7, wherein the purchase propensity module derives the purchase propensity data based on one or more of the following:
number of transactions and amount spend;
velocity of spend;
seasonality of spend; and
average transaction amount.

10. The system of claim 7, wherein the purchase propensity module determines the purchase propensity data based on responsiveness to past offers or discounts.

11. A system for an online merchant to provide a targeted offer based on purchase propensity information, the system comprising:
a processor;
a sales management module executable by the processor and adapted to:
establish an online browsing session with a customer;
retrieve purchase propensity data associated with the customer; and
determine a targeted offer for the customer based on the retrieved purchase propensity data while the browsing session is in progress.

12. The system of 11, wherein the sales management module retrieves the purchase propensity data which is based on historical data for purchases made from a plurality of merchants.

13. The system of claim 11, wherein the sales management module retrieves the purchase propensity data which is based on one or more of the following:
number of transactions and amount spend;
velocity of spend;
seasonality of spend; and
average transaction amount.

14. The system of claim 11, wherein the sales management module retrieves the purchase propensity data which is based on responsiveness to past offers or discounts.

15. A method for providing online merchants with purchase propensity information comprising:
receiving, from an online merchant computer, a message containing a customer identifier that identifies a customer who has established an online browsing session with the online merchant; and
responsive to the received message, transmitting to the online merchant computer purchase propensity data associated with the identified customer while the browsing session is in progress.

16. The method claim 15, further comprising determining the purchase propensity data based on historical data for purchases made from a plurality of merchants for the identified customer.

17. The method of claim 15, further comprising retrieving the purchase propensity data from a purchase propensity database that stores purchase propensity data for a plurality of customers.

18. The method of claim 15, further comprising determining the purchase propensity data based on one or more of the following:
number of transactions and amount spend;
velocity of spend;
seasonality of spend; and
average transaction amount.

19. The system of claim 15, further comprising determining the purchase propensity data based on responsiveness to past offers or discounts.

20. A computer readable storage medium containing software code which, when executed by a processor, performs the method of claim 15.
